(19) United States
(12) Patent Application Publication
(10) Pub. No.: US 2006/0236872 A1
(43) Pub. Date: Oct. 26, 2006

(54) Machine for making thin flatbread

(76) Inventors: Robert Burton Nordberg, St. Paul, MN (US); Rajagopalan Chandrasekhar, Maryland Heights, MO (US)

Correspondence Address: Robert B. Nordberg, 2286 Long Avenue, St. Paul, MN, 55114, US

(21) Appl. No.: 11/111,227

(22) Filed: Apr. 21, 2005

(51) Int. Cl. A47J 37/06

(52) U.S. Cl. 99/349

(57) ABSTRACT

A flatbread making machine comprised of a manually loaded flour bin and a manually loaded water tank. A flour and a water dispenser. A pair of batch mode devices each of which performs the actions of a mixer and a dispensing pump. An endless sheet of dough extruder discharging vertically downward onto an inclined hot plate. A hot plate vibrator. A second inclined hot plate. A tension-limiting means including a light sensor and a pair of rollers which passes the sheet either through a cutter and batch-gathering means or through a serrator followed by a vertical pass through oven and then through a cutter and batch-gathering means.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF INVENTION

1. Field of Invention

This invention is related to food processing machinery, specifically processing flatbread which is baked in thin sheets and does not require slicing.

2. Prior Art

Some typical names of flatbreads are tortillas, rotis, and chappatis. When flatbread is made by hand, flour and water are mixed in the ratio of approximately 12 to 5 by volume, but this ratio varies depending upon the particular grain and moisture content. It is then separated into balls of about 1 ½ inches in diameter and flattened with a rolling pin into discs of about 1/16 inch thick. The discs are then cooked on a hot plate at approximately 400 degrees F. for approximately 40 seconds each side, and the process is then complete. Some flat breads, for instance chappatis, are given a reduced time for cooking and then given a final bake over a flame for approximately 10 seconds while it is agitated to prevent any portion from burning. During this final baking period, the disc expands like a balloon due to internally produced steam, but finally flattens as it subsequently cools. Many machines have been designed which simulate this manual process. The hardest step to duplicate was rolling or pressing the ball of dough into a sheet because the dough disc would stick to the rollers or platens. To discourage sticking a sprinkling of flour can be placed on the platens or rollers or a non-stick organic compound can be coated onto the platens and rollers. In either case, however, a close eye must be kept on the pressed dough which occasionally requires manual intervention after the flattening process.

Machines which extrude the dough through a narrow slot eliminate the sticking problem which occurs during rolling or pressing. Mechanisms to release the dough from various surfaces that the dough subsequently contacts, however, must still be implemented. Steps requiring this attention are cutting the desired shape, typically round, from the sheet of dough; separating the discs from the remaining sheet of dough; and returning the unused portion to the mixer. These returned pieces however, leave the dough in a less flexible condition which can later cause breakage.

Machines which make pastry, chips and snack foods use different ingredients from the hard wheat used to make bread. Hard wheat contains 12 to 15% protein, it is rich in gluten and makes fine bread flour due to its good elasticity, pleasing taste and savory aroma. Soft wheat contains only 7 to 11% protein, it tends to be rich in starch and low in gluten, and lacks the stickiness needed for bread making. It is used in pastries and often mixed with hard wheat. In machines which extrude a sheet of dough for making pastries, chips and snack food; therefore, there is no need to guard against sticking to subsequent surfaces. The Hilton patent (U.S. Pat. No. 4,126,706) uses mixtures of grain, corn and potato solids to make chips and snack food. Using these compositions, it encounters no problems with the sheet of dough sticking to a conveyor used to transport the sheet of dough from the extruder to the dough conditioner. For the same reason the Ally patent (U.S. Pat. No. 4,651,635) is not subject to sticking to the hot plate which is orientated at an angle to the horizontal when the sheet of dough is transferred between the extruder and the moisturizing station.

### BACKGROUND OF INVENTION—OBJECTS AND ADVANTAGES

The primary object of the present invention is to provide a high speed, compact, inexpensive and simple method for making flatbread such as tortillas, rotis, and chappatis. This disclosed process eliminates the steps used in the conventional machines of separating dough discs from the endless sheet of dough and returning the unused portion to the mixer, as taught by Rubio et al (U.S. Pat. No. 5,565,220). It also eliminates the problem of having preformed balls sticking to platens after flattening as taught by Ribio et al (U.S. Pat. No. 5,006,358)

In the present invention a sheet of dough is extruded through a narrow slot. Under the influence of gravity this sheet is allowed to first contact and then to slide along an inclined hot plate which is coated with a non-stick organic compound. The opposite surface of the endless sheet is then cooked by allowing it fall onto a second non-stick hot plate inclined in the opposite direction. Any handling after cooking both sides is completely free of sticking because the surface has become dry, yet the sheet is still flexible. The mechanisms used in existing machines to release the flattened high gluten dough from handling surfaces are therefore eliminated yielding a simpler machine.

As the extrusion travels along the hot plates, its weight can become excessive and cause breakage of the extrusion at the extruder exit where it is weakest. A tension-limiting device is therefore required. The tension is controlled using two compressively-gripping rollers and a light-sensing switch. The switch responds to the reflected light from the sheet of dough suspended between the extruder and the top surface of the first hot plate. When the catenary formed by the sheet is high, the compressively-gripping rollers are stopped. When the catenary is low, the compressively-gripping rollers are turned at a speed greater than the sheet speed. Thus the compressively-grippng rollers follow the extruder speed and at the same time prevent excessive tension.

When the sheet contacts the first hot plate during startup, sticking occurs until the sheet lenghtens and gravity overcomes the adhesion. During this initial period an adhesion-reduction means is implemented such as blowing dry air over the emerging extrusion, spot radiating the emerging extrusion, prodding the sheet with a pick after alighting on the hot plate, or mechanically vibrating the hot plate. The latter is the preferred embodiment. The adhesion-reduction is no longer necessary once the sheet is moving on the second hot plate.

For low volume installations, a hopper and pump can be used to supply the extruder with dough, or the dough can be manually loaded into the extruder. For long runs, the preferred embodiment, two separate dough mixers are incorporated to provide a continuous flow of edibles. As one mixer is mixing a load of dough the second mixer is dispensing a load into an extruder, resulting in the endless sheet of dough. For these installations flour and water are automatically measured and dispensed into each mixer. Salt is manually measured and added to a water tank each time the water tank is refilled. A large flour bin and elevator are added to make it convenient to manually load the flour at table-top level.

Typically in a mixing and extruding process, a pump is inserted between a mixer and extruder. This item has been eliminated in the present design by shaping the impellers to perform both the mixing and the pumping activity. Each mixer contains two impellers. Each impeller pair can be thought of as rotating-meshed gears, except that each gear has only two teeth that are precisely driven so that mating teeth come close to each other but don't actually contact. The shape of the impeller is roughly a rectangular loop, i.e. the two toothed gear in the aforementioned simulation. The mixing chamber consists of two axially parallel intersecting horizontally oriented cylinders with roughly a figure “8” cross-section so that the long sides of the rectangular impellers hug the chamber walls during rotation. The rotating shafts of the impellers are positioned as close together as possible so that each impeller in turn will scoop out the dough which resides on the centerline of the other, providing for efficient mixing. A long axial window or gate in the mixing chamber wall allows the impellers to pump the dough out of the chamber when open, and to mix the dough when closed.

If it is desired to have the flatbread expand like a balloon, the partially cooked dough is sent through an oven. To facilitate this step in the preferred implementation, serrations are created perpendicular to the sheet length, which define typical sized servings. The unsevered but serrated sheet is then simply lowered vertically through an oven eliminating a horizontal conveyor system. Another advantage of an unsevered cooked sheet of flatbread is obtained by rolling or layering the finished product into a bundle which will better retain its heat prior to severing at the serrations and serving individual slices.

A microprocessor controls the main process. A buzzer will be actuated when the flour level in a manually loaded bin becomes too low. This bin is slightly less than a meter above the floor for convenient loading. An elevator lifts the flour to a smaller flour container approximately two meters above the floor level where exact measures offflour are dispensed into the mixers via fixed sized cavities and gravity. A buzzer will be actuated when the liquid level in a manually loaded water tank becomes too low. This tank is approximately two meters above the floor. A stepper motor controlled hydraulic cylinder in conjunction with one-way valves dispenses water into the proper mixer. Two sensors provide for the flour and water to be mixed to the desired consistency. They are a light-sensing switch which counts holes in a disk mounted on the compressively-gripping rollers. This count can be used to calculate the quantity of dough dispensed and indicates when the mixer is empty. Amperage sensors connected to the two DC mixing motors, yield a measure of the viscosity which is then used to finely adjust the mixing ratio when filling. In order to insure that flour does not cavitate in the various stages of the process, agitation is provided at the various bins and dispensing cavities. Stepper motors are typically used for this purpose. Though not absolutely necessary most of the routine tasks are controlled by the microprocessor such as maintaining the temperatures of the oven and two hot plates and actuating the serrator, the adhesion-reduction means, the cutter, and the batching means.

The simplest shape of the final bread is rectangular or square. This process will require a break from the traditional round shape in the interest of reduced costs. On the other hand circular shaped breads, or any other desired shape, can be cut from the cooked endless sheet if a market is found for the remaining pieces. This particular machine is targeted for the restaurant industry and therefore does not include a packaging function at the end.

### SUMMARY

In accordance with the present invention a flatbread making machine is manually loaded with flour, water, and salt; and delivers finished batched flatbread.

### DRAWINGS—FIGURES

FIG. 1 shows a pictoral of the preferred embodiment of the machine.

FIGS. 2 & 3 show perspective views of the combination mixer-pump.

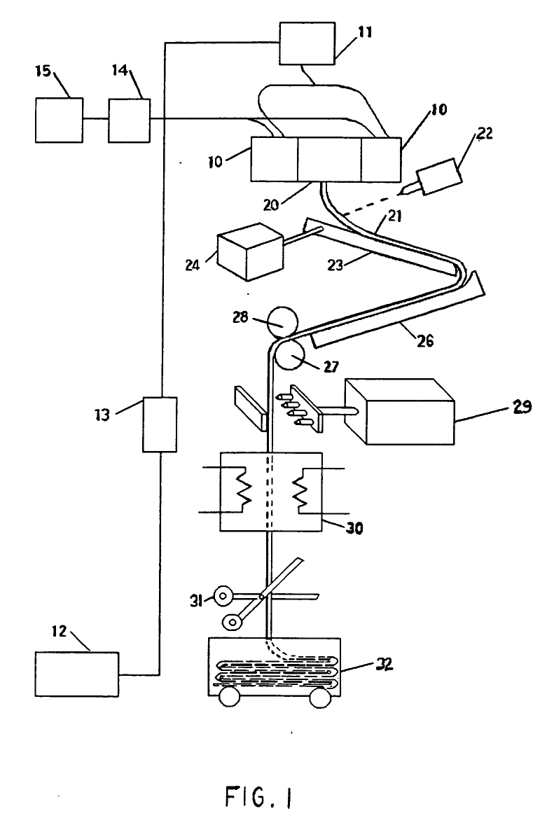

### DETAILED DESCRIPTION—FIG. 1—PREFERRED EMBODIMENT

As illustrated in FIG. 1 the preferred embodiment of the machine indicates two batch-mode combination mixer-pumps 10 that are alternately fed flour through a particulate dispenser 11 which is kept filled via a manually filled particulate bin 12 an automatic particulate elevator 13. Each combination mixer-pump is also fed water from a liquid dispenser 14 which is supplied from a liquid holding-tank 15. This tank is manually batch filled with a predetermined ratio of water and salt.

An endless sheet of dough generator 20 extrudes the dough through a long narrow slot vertically downward. The sheet of dough 21 cuts through a light beam from a disposed light-sensing switch 22 and then contacts a first hot plate 23 coated with a non-stick organic compound, such as tetraflouroethylene, and which is inclined slightly downward from the horizontal. When the endless sheet of dough initially contacts the first hot plate, it is prevented from sticking by an adhesion-reduction means 24 connected to the first hot plate. When the dough sheet travels beyond the first hot plate it encounters a second non-stick hot plate 26 which is also inclined downward to the horizontal but facing in the opposite direction which allows the opposite surface of the dough sheet to cook. If a short turn-around is desired between the two hot plates, an upward concave lip can be added to the top end of the second hot plate to guide the leading edge of the endless sheet.

In order that gravity acting on the deployed sheet not pull too hard and sever the uncooked sheet immediately exiting the extruder, a tension-limiting means is incorporated. This includes the aforementioned light-sensing switch, as well as a bottom roller 27 and a compressively-engaged top roller 28 which are placed after the second hot plate. A serrating means 29 creates well defined, preferably square, sections upon the dough sheet and this sheet continues through a vertical pass-through oven 30 under the influence of gravity. The serrations prevent puffing from occurring at the serrated points so that the chappatis are shaped like a string of connected pillows until they cool. A cutting means 31 then separates the sheet after the desired quantity of flatbread is gathered up in a batching means 32.

Alternative Embodiments

(a) If the puffing process is not desired, the flatbread is thoroughly cooked on the hot plates and the vertical pass-through oven is not required.

(b) If a low volume machine is desired, The extruder can be loaded by hand, or a pump and manually loaded dough container can replace items 10-15 i.e. the combination mixer pumps, the particulate dispenser, the particulate bin, the particulate elevator, the liquid dispenser, and the liquid holding-tank.

Operation

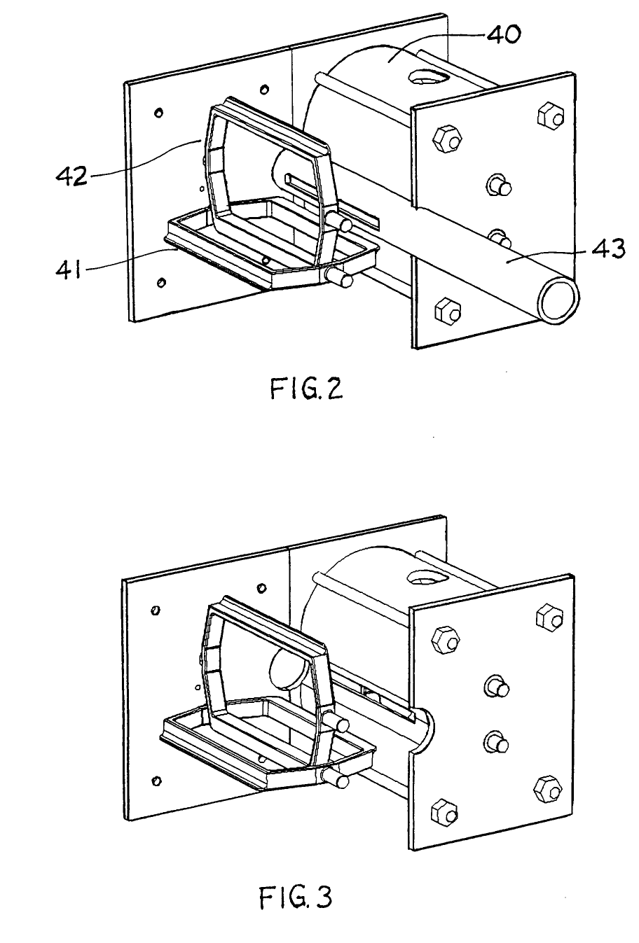

The combined mixer-pumps are shown in FIGS. 2 and 3. In both figures the mixing chamber associated with the mixer on the left has been removed to allow viewing the internal components and the flow path of the mixture. As shown in FIG. 2, the top impeller 42 and bottom impeller 41 are synchronously driven so that they mesh but do not contact each other. The shape of the mixing chamber 40 is that of a figure “8”. This allows the impellers to hug the inside walls of the chamber which provides for efficient mixing and dispensing.

An extruder tube 43 with an internal auger (not shown) is positioned between the two mixers and can communicate, one at a time, with either mixer. Windows on either side of the extruder tube can be aligned, through angular rotation, with mating windows in the mixing chambers. By so doing, one mixing chamber is selected to dispense its mixture, while the other mixer is isolated and is enabled to begin mixing a new batch of dough.

When dispensing, pumping action is enhanced by the addition of a radial directed blade at the maximum radius of the impeller. This blade, observable on the top of impeller 42 and also on the left side of 41, gathers dough while rotating and pushes it into the extruder tube during the dispensing cycle. The top and bottom impellers are mirror images of each other; by having the top impeller rotate CCW while the bottom impeller rotates CW as shown in the exposed mixer on the left, the blades on both impeller can gather up dough in the cavities formed. FIG. 3 has the auger tube removed exposing the mating window in the mixer casing of the right hand mixer.

Advantages

From the description above, design simplicity, reduced overall size, and reduced cost in manufacturing this flatbread making machine are possible:
(a) The three separate units: mixer, conveyor, and pump have been combined into a single unit. This eliminates the transfer operation previously performed by the conveyor.
(b) The mixer and pump have been combined into a single unit, essentially eliminating one unit.
(c) The tension limiting system allows for a vertically orientated oven and the elimination of a horizontal oven conveyor.
   Conclusions, Ramifications, and Scope

By accepting the rectangular shape for the flatbread, the endless sheet of dough can be completely baked while remaining integrally intact. A simplified manufacturing process is now obtainable by not having to discard scrapped pieces, and not having to contend with the problems associated with separating and reassembling uncooked product encountered with previous machines. Sensors determine the electrical load on the mixing motors and provide a means for calculating the quantity of dough in the mixer. These variables allow for the exact viscosity of the dough to be determined and modified in order to yield consistency and a high quality product.

It is thought that the present invention and many of its attendant advantages will be understood from the forgoing description. Various changes could be made in the form, construction, arrangement of the parts, and selection of product ingredients without departing from the spirit and scope of the invention or sacrificing all of its advantages. The machine herein described is merely a preferred or exemplary embodiment of the process.

What is claimed is:

1. A combination mixing and pumping means, comprised of two opposite rotating horizontally orientated meshing rectangular loops with chamfered corners, and a closely fitted double lobed concave mixing chamber, said loops and chamber constituting a mixing means, when isolated, and a dispensing means to dispense derived mixture when an opening is introduced in the mixing chamber at one of the lobe intersections.

2. A two point suspended moving-sheet tension-limiting means, comprised of a position sensing means and a conveying means, said position sensing means sensing sheet vertical elevation intermediate the two suspended points and said conveying means controlling sheet uptake velocity.

3. A machine for making flat sheet edibles comprising of a frame which houses control elements and the following components:
(a) An extruding means,
(b) A tension-limiting means of claim 2,
(c) An adhesion-reduction means,
(d) Two sequentially disposed hot plates inclined in opposite directions.

4. The machine of claim 3 further including a severing means.

5.The machine of claim 3 further including:
(a) A serrating means,
(b) A vertical pass-through oven,
(c) A severing means.

6. The machine of claim 3 further including:
(a) A serrating means,
(b) A vertical pass-through oven,
(c) A batching means,
(d) A severing means.

7. The machine of claim 3 further including:
(a) A particulate bin,
(b) A particulate elevator,
(c) A particulate dispenser,
(d) A liquid holding-tank,
(e) A liquid dispenser,
(f) Two combination mixing and pumping means of claim 1,
(g) A severing means.

8. The machine of claim 3 further including:
(a) A particulate bin,
(b) A particulate elevator,
(c) A particulate dispenser,
(d) A liquid holding-tank,
(e) A liquid dispenser,
(f) Two combination mixing and pumping means of claim 1,
(g) A batchng means,
(h) A severing means.

9. The machine of claim 3 further including:
(a) A particulate bin,
(b) A particulate elevator,
(c) A particulate dispenser,
(d) A liquid holding-tank,
(e) A liquid dispenser,
(f) Two combination mixing and pumping means of claim 1,
(g) A serrating means,
(h) A vertical pass-through oven,
(i) A severing means.

10. The machine of claim 3 further including:
(a) A particulate bin,
(b) A particulate elevator,
(c) A particulate dispenser,
(d) A liquid holding-tank,
(e) A liquid dispenser,
(f) Two combination mixing and pumping means of claim 1,
(g) A serrating means,
(h) A vertical pass-through oven,
(i) A batching means,
(j) A severing means.
